(19) United States
(12) Patent Application Publication
(10) Pub. No.: US 2025/0258073 A1
(43) Pub. Date: Aug. 14, 2025

(54) SYSTEM FOR IN SITU MEASUREMENT IN AN AUTOCLAVE AT HIGH TEMPERATURE, HIGH PRESSURE, AND HOSTILE ENVIRONMENT

(71) Applicants: ALLEN DENZINE, Willoughby, OH (US); Derrek Leiter, Eastlake, OH (US); Genti Cini, Rocky River, OH (US)

(72) Inventors: ALLEN DENZINE, Willoughby, OH (US); Derrek Leiter, Eastlake, OH (US); Genti Cini, Rocky River, OH (US)

(21) Appl. No.: 18/438,783

(22) Filed: Feb. 12, 2024

(51) Int. Cl. G01N 3/18; G01N 3/06

(52) U.S. Cl. CPC G01N 3/18; G01N 3/066

(57) ABSTRACT

A system, method, and process for direct, precise measurement of extension/strain of a metallic round or flat tensile specimen or measurement of crack growth rates on a metallic CT specimen under control forces of extreme temperature, pressure and adverse environment are applied to a pre-crack metallic specimen within an autoclave.

### FIELD OF THE INVENTION

The invention disclosed herein relates to tensile testing of materials, primarily metallic materials, and more precisely to the direct measurement of the extension strain of a specimen subjected to high temperature, pressure, and hostile environment within an autoclave.

### BACKGROUND, HISTORY OF THE PRIOR ART, GOALS OF THE INVENTION

Tensile testing of materials, primarily metals, has been ongoing for many years using round or flat tensile specimens. Most all tests are performed under either ambient conditions or perhaps at high temperature and ambient pressure. In all cases, load is measured using an external load cell. In the case of ambient testing, extension (strain) is measured using an extensometer that attaches to the test specimen. At high temperatures and pressures, such clip-on extensometers will not survive, so strain must be measured externally. External strain measurement is much less accurate than direct extensometer measurement.

In recent years, in addition to standard tensile testing, there is increasing interest in the fracture toughness of a material. The fracture toughness relates to the resistance of a material to the rapid propagation of an existing crack. For example, will a crack in an airplane wing rapidly grow or will it blunt itself and stop growing. For this type of testing, a different type of specimen is used, a CT (Compact Tension) specimen. A CT specimen is pre-cracked and is then subjected to cyclic fatigue loading, and the crack will grow normal to the loading axis. In order to measure the crack growth, a technique called DCPD (Direct Current Potential Drop) is used.

For ambient tests, extension can be measured using a clip-on extensometer. For elevated temperature and pressured tests, elongation must be measured externally, with its attendant errors.

The test specimen inside the autoclave is loaded externally through a pull-rod that penetrates the autoclave wall and moves through a sliding seal as illustrated below. This autoclave, which operates a high temperature and high pressure, will also contain liquid or gaseous environments to simulate the situation in question. Examples such as high purity water in a nuclear reactor, or oil/water/natural gas mixtures in a pipeline, or a gaseous or gas liquid hydrogen environment are of great interest to study.

Because of the high temperature and high pressure, external strain measurement using an extensometer inside the vessel is not possible. The only existing methods of eternal strain measurement are either to measure the external movement of the crosshead of the load frame, or to use an external measurement of the movement of the pull-rod. Both external measurement techniques are highly inaccurate compared to direct measurement because of the stretching of all the components in the system, (pull rod, grips, pivot pins, insulators, load cell), contribute to the total strain measured. These error sources are so large as to mask the actual extension of the test specimen. Programming the load frame to make precise fatigue cycles based on specimen elongation (typically a sine wave) at the specimen is near impossible because of all the sources of error.

As such, a primary object of the present invention is the direct measurement of strain produced a CT, compact tension, SENT, single edge notched tensile, a round or a flat specimen under elevated temperature and pressure within an autoclave, thereby overcoming inaccuracies of high pressure and high temperature testing.

A secondary object of the present invention is the direct measurement of strain produced on a round, flat, CT (compact tension), or SENT (single edge notched tensile) specimen under elevated temperature and pressure within an autoclave, thereby obviating the need for an extensometer.

Another objective of the present invention is the direct measure of strain on the specimen for avoidance of external measurement of the load frame crosshead or movement of the pull rod with their concomitant inaccuracies due to stretching of all components of the system.

A first reference is a Swedish article, IGSCC Crack Propagation Rate Measurement in BWR Environments, Executive Summary of a Round Robin Study by Peter L. Andresen, Nuclear Engineering and Technology, Vol. 54, Issue 12, December 2022, Pages 4481-4490, ISSN 1104-1374 ISRN SKI-R-98/27-SE, STA TENS KARN, KRAFTINSPEKTION, Swedish Nuclear Power Inspectorate, SE9900158, https://www.sciencedirect.com/science/article/pii/S1738573322003515

The study teaches the use of water in an autoclave, does not distinguish external versus internal measurements with isolation of electronics and the specimen, but does demonstrate prior efforts at methods for crack rate analysis.

The second reference is U.S. Pat. No. 8,290,111 B1, titled Electrochemical Corrosion Potential Device, (Oct. 16 2012), That invention relates to the determination of electrochemical corrosion potential for components in a nuclear power plant.

A third reference is from Russia, A SIMPLE DEVICE FOR MONITORING CRACKS FROM PHOTOGRAPHS, A. E. Wojnarowski, A. B. Leonteva, E. S. Soonvald, PHOTOGRAMMETRIA Research and Production Enterprise, St. Petersburg, Russia, info@photomicrometer.com, info@photogrammetria.ru, Saint Petersburg State University, Department of Cartography and Geoinformatics, St. Petersburg, Russia-a.vojnarovsky@spbu.ru, Commission V, WG V/7isprs-archives-XLVI-5-W1-2022-245-2022.pdf.

The technique used by the authors of the paper takes sequence snapshots at intervals over time, which are then stitched together to obtain some time-based idea of crack growth.

Another reference is U.S. patent Ser. No. 12/000,129, Jun. 30, 2009, which relates to a device and system for monitoring gas effusion from a pipe.

Still another citation is U.S. Pat. No. 4,836,029, dated Jun. 6, 1989, that relates to materials testing, and more particularly to a method and apparatus for determining crack growth in elastomeric test specimens.

At present, to reduce carbon footprint, companies are introducing up to 20% hydrogen gas into existing natural gas pipelines. Hydrogen has a well-documented property of embrittling steel. So, regulators and pipeline operators need to answer the question of how much hydrogen, at what temperature and pressure and what length of pre-existing defects can be tolerated without causing a pipeline failure. With this new system, we can now offer a means to accurately answer that important question.

### SUMMARY OF THE INVENTION

The disclosure is a system, method, and process for direct, precise measurement of strain on a round or flat tensile specimen or crack growth rate for a CT or SENT specimen as control forces of extreme temperature, pressure and hostile environments are applied to a previously pre-cracked metallic specimen within an autoclave.

There are several unique features to this design.
1. Of greatest importance is that this system allows, for the first time, the ability to measure extension directly at the metallic specimen while it is in a high temperature high pressure hostile environment.
2. The accurate direct measurement of displacement greatly improves the precision of cyclic loading waveforms and permits the accurate calculation of crack growth rates.
3. Normally, LVDTs have a floating core from which the extension can be calculated. Our innovation utilizes a specially modified LVDT wherein the core is within a pressure boundary such that the internal portion of the LVDT sees full system pressure.
4. The accurate direct measurement of extension greatly improves the precision of cyclic loading waveforms and permits the accurate calculation of crack growth rates.

The system is suitable for round, flat, CT, or SENT specimens. This technique measures strain/crack length continuously in real time, thereby permitting graphs of strain vs time, stress vs strain, crack length vs time in a continuous smooth curve.

### BRIEF DESCRIPTION OF THE DRAWINGS

FIG. 1 depicts a Compact Tension, CT, specimen, a single edge notched tension, SENT, specimen, a round tensile specimen, and a flat tensile specimen.

FIG. 1A depicts a spent pre-cracked CT specimen with effects of hostile environment.

FIG. 2 depicts a complete system with load frame, autoclave, load frame control module and DCPD module.

FIG. 3 depicts a cut-away of a pressure vessel showing a specially modified LVDT, the core thereof within a pressure boundary such that the internal LVDT sees full system pressure.

FIG. 4 depicts the technique applicable to a round specimen within the autoclave, showing electrical isolation.

FIG. 5 is a cutaway view of a high temperature high pressure vessel showing the system applicable to flat specimen.

FIG. 6 is a schematic view of the complete system with the pressure vessel, grips, LVDT assemblies, electrical separation and enclosure, and computer operative using proprietary operating software.

### DETAILED DESCRIPTION OF THE INVENTION

In recent years, in addition to standard tensile testing, there is increasing interest in the fracture toughness of a material. The fracture toughness relates to the resistance of a material to the rapid propagation of an existing crack. For example, will a crack in an airplane wing rapidly grow or will it blunt itself and stop growing.

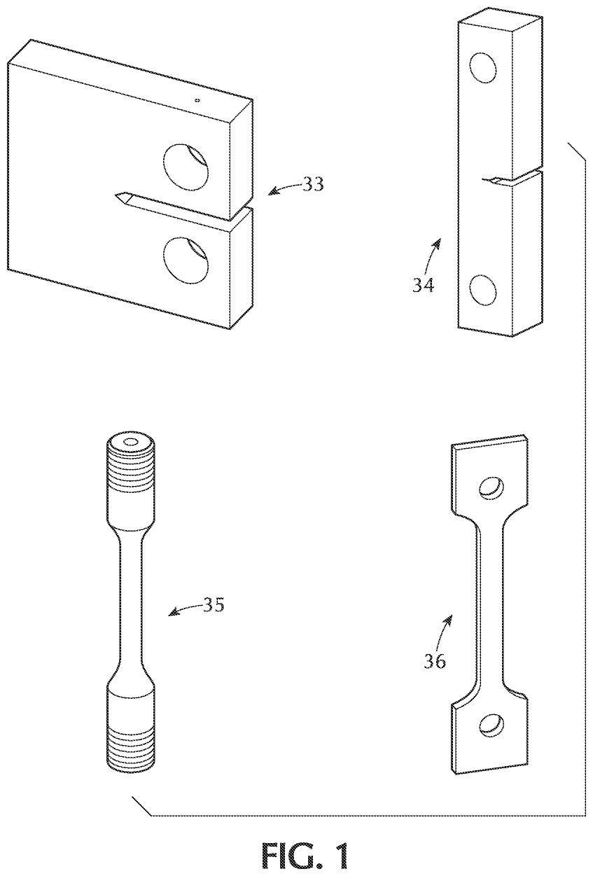

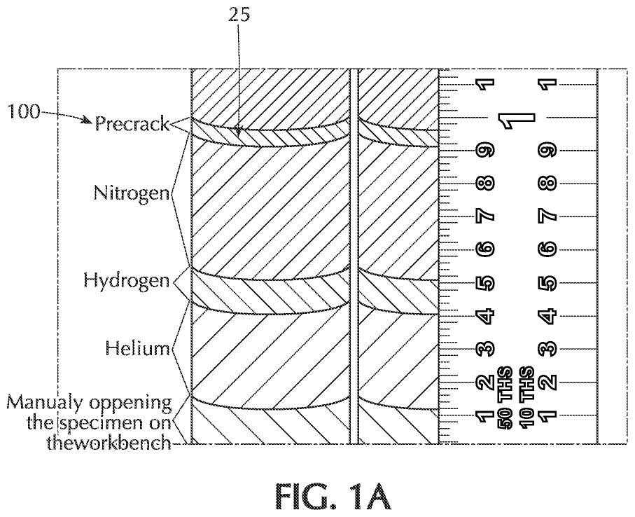

For this type of testing, a different specimen is used, called a CT, Compact Tension, specimen 33, shown in FIG. 1. A CT specimen is pre-cracked, 100 shown in FIG. 1A, and is then subjected to cyclic fatigue loading, and the crack will grow normal to the loading axis. To measure the crack growth, a technique called DCPD, Direct Current Potential Drop is used. In this case, an electrical current is passed through the specimen, and as the crack grows, the resistance of the remaining material increases and the potential drop across the specimen can be measured with a nanovoltmeter.

This voltage change can be used to calculate crack length. This type of specimen must be electrically isolated from the load frame 3, and all load components. For ambient tests, extension can be measured using a clip-on extensometer. FIG. 1 also displays the single edge notched tension SENT specimen 34, a round tensile specimen 35, and a flat tensile specimen 36.

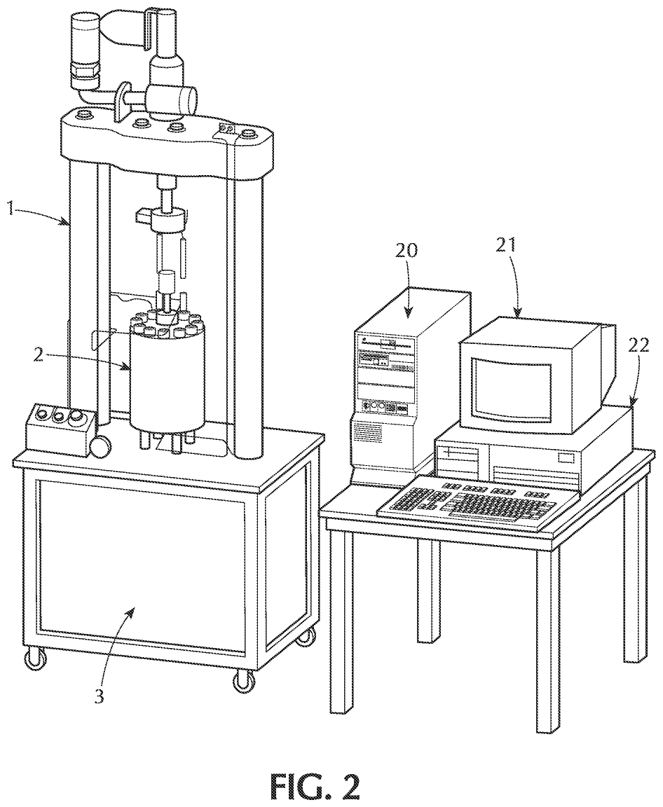

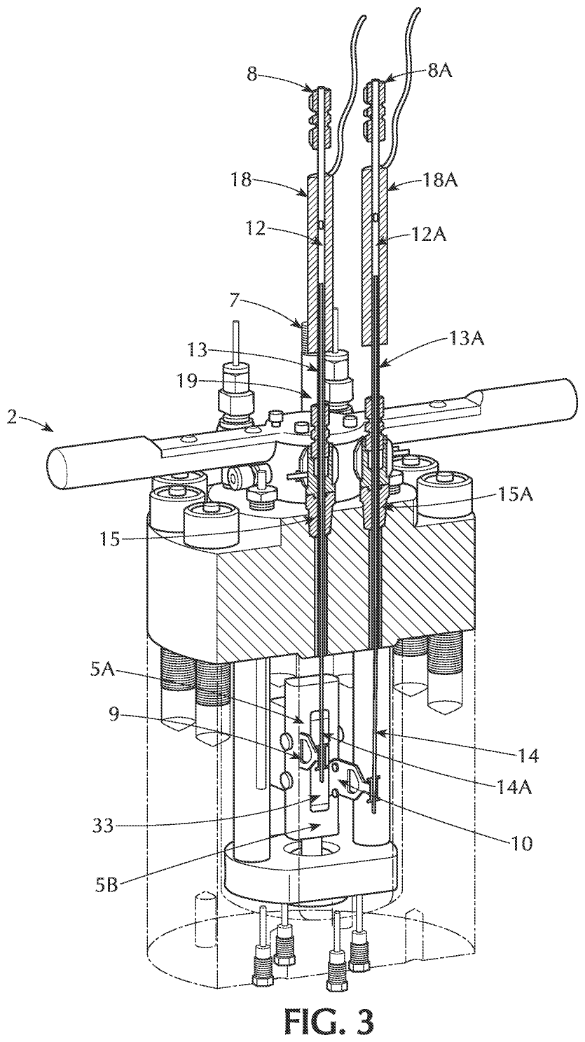

In prior elevated temperature tests, elongation by necessity was measured externally, with its attendant errors. FIG. 2 portrays the complete system with load frame 1, autoclave 2, a system controls load frame 3, and direct current potential drop module, DCPD, 22. FIG. 3 of the drawings shows a cutaway view of the autoclave. The specimen 33 is pinned in place upon specimen grips 5A, 5B. Mounted to the grips are an upper 9 LVDT, Linear Variable Differential Transformer, rotatable bracket and a lower LVDT rotatable bracket 10, each bracket contacting the specimen. A slidable rod 14, 14A A pressure barrier 13, 13A retains pressure within the vessel 2 and extends well above the autoclave body 2 such that autoclave elevated temperatures and pressures in the autoclave do not affect LVDT performance. As the load is applied and the specimen 33 elongates, contiguous LVDT brackets are displaced concomitant with upward force on the rods 14, 14A in articulation with the brackets. Each rod retains an LVDT 18, 18A positioned apart from the pressure vessel 2. The ultimate difference in measurement between the LVDTs is the actual extension of the specimen. This technique accounts and compensates for expansion errors, such as expansion of metallic components and threads.

This new and unique technology enables measurement of extension directly at the specimen that is inside an autoclave at high temperature, high pressure and in a hostile environment. It is suitable for round, flat, SENT and CT specimens.

In the case of round 35 or flat 36 tensile specimens, see FIG. 1, the same technique is used, and the LVDT rods are attached to the specimens using spring energized clips. As such, the system for a tensile test of a metallic pre-cracked specimen emanates from the confined space of an autoclave which includes a means for applying a load of high temperature, high pressure and adverse environment upon the specimen and a means for a direct measurement of a specimen extension responsive to the load.

This system provides the load frame 3, FIG. 2 in fluid communication with the autoclave 2 for production of high temperature, high pressure and hostile environment therein.

The specimen is loaded through a pull-rod 7 that penetrates the autoclave wall and moves through a sliding seal 19, FIG. 3, and the specimen is pinned between two specimen grips 5A, 5B fixed to the pull-rod. The system includes upper 9, and lower 10 LVDT movable brackets each bracket in direct contact with and responsive to the specimen strain expansion. Each bracket is joined to an upright vertical rod 14, 14A that extends outside the autoclave. Each rod 14, 14A serves as a slidable core 12, 12A of its respective LVDT 18, 18A, whereby rectilinear motion of the upright rods, displaced through a sliding autoclave seal 15, 15A, is converted to a corresponding LVDT electrical signal. Each LVDT is modified such that the core thereof is within a pressure boundary or barrier 13, 13A whereby an internal LVDT submits to full system pressure. The pressure barrier 13 13A extends well above the autoclave such that a high autoclave temperature does not affect LVDT performance. The system is closed at tube ends 6, 6A, and secured with caps 8, 8A fixed on the distal, upper end of each slidable rod 14, 14A.

The load applied elongates the specimen with consequent movement of the LVDTs. A resultant difference in measurement between the upper 18 and lower 18A LVDT is an actual extension of the specimen. Such direct measurement of a specimen extension enables precision of a plurality of cyclic loading waveforms and permits accurate calculation of crack growth rates for a CT compact tension specimen 33 or SENT single edge notched tension specimen 34, and extension or strain for a round 35 or flat tensile specimen 36.

Note that each metallic specimen includes a pre-crack 100, see FIG. 1A, prior to the tensile test for Compact Tension (CT) specimens, wherein a spent specimen 25 is shown. Furthermore, the aggressive environment within the autoclave comprises a gas mixture selected from a group comprising nitrogen, hydrogen, carbon, oxygen, steam, or a combination thereof such as H2S, CO2, or CH4.

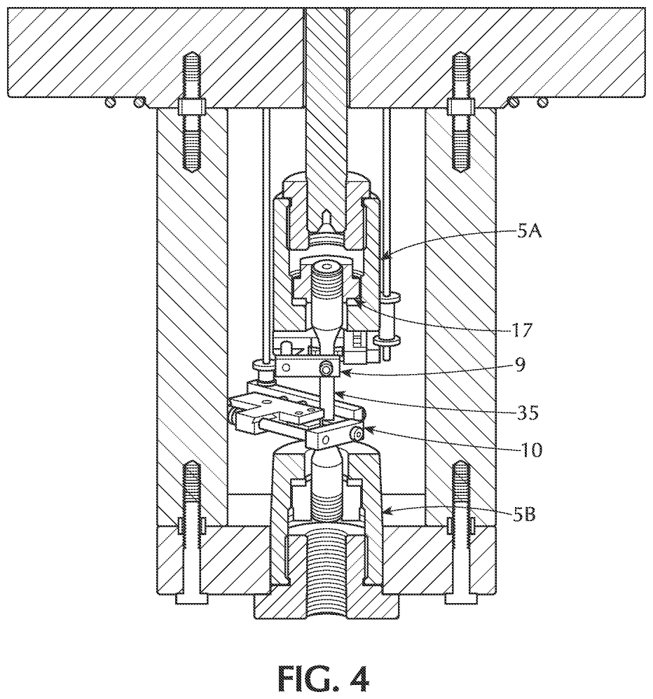

The aggressive environment also includes a condition of combined elevated temperature and elevated pressure, which is provided in the autoclave, at temperatures up to 600 C and pressures up to 41 MPa (6000 psi). Meanwhile, an electrical isolation of the specimen is maintained by electrical isolation washer 17 in FIG. 4, which is necessary to prevent galvanic reactions between the specimen and the grips.

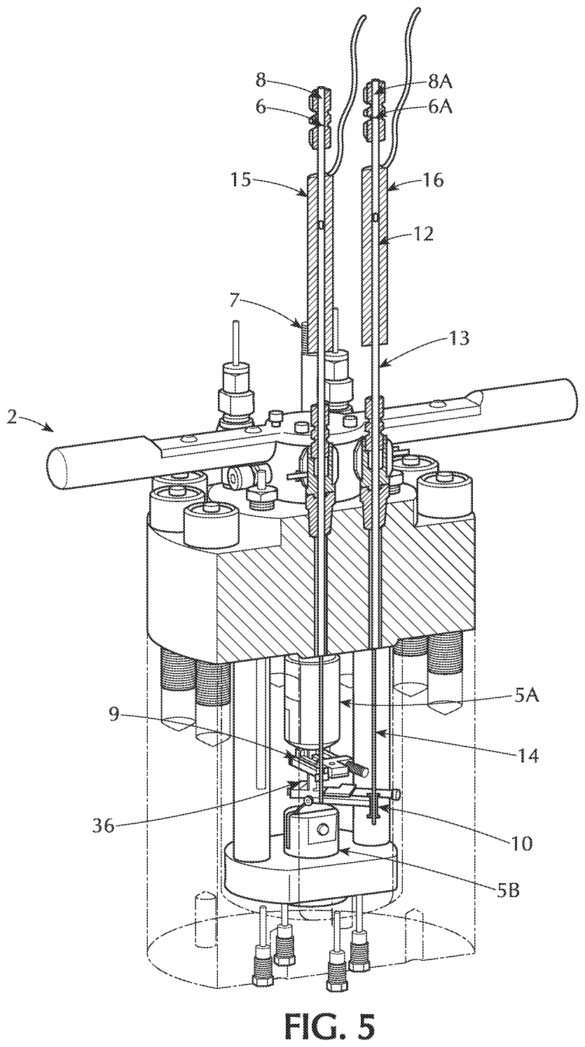

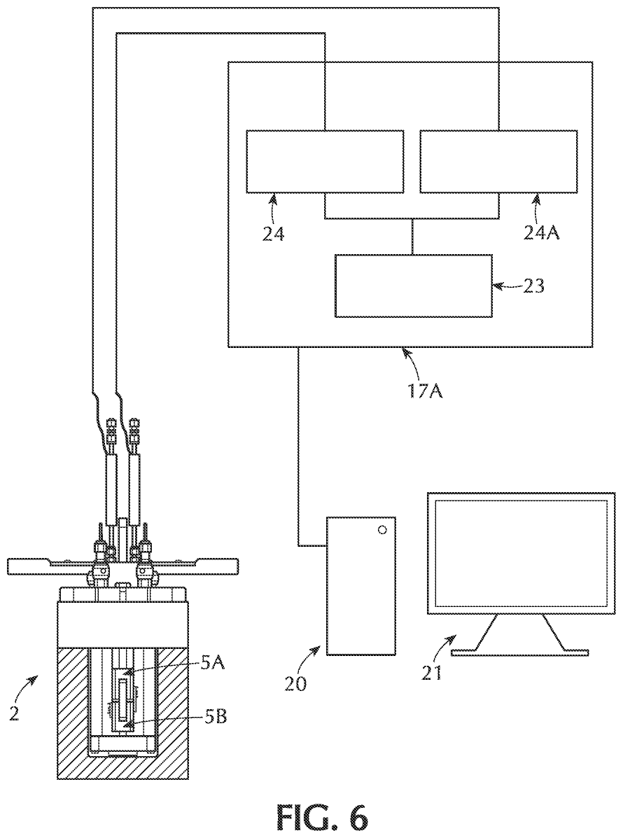

As shown in FIGS. 4, upper 9, and lower 10 LVDT movable brackets directly contact a round specimen 35 for response to the specimen strain expansion. Referring now to FIG. 5, a close-up cutaway view, the technique also applies to and flat tensile specimens 36, within the autoclave. A schematic view of the complete system is in FIG. 6. The system includes the pressure vessel with grips 5A, 5B, FIGS. 3-5, and LVDT assemblies. Computer 20, with display 21, employ proprietary operating software. This system measures continuous stress-strain behavior inside a pressure vessel 2. Application of strain/extension resulting in direct specimen expansion measurement is key, that measurement is output to a direct current drop DCPD module 22, FIG. 2, and associated computer 20, display 21 for plotted graphs. In the DCPD process electrical resistance of a specimen increases simultaneous to crack propagation with resultant potential drop, whereby crack length is determined. In reference to FIG. 6, full electrical isolation 17A is maintained with separation and enclosure of the power supply 23, and the signal conditioners 24, 24A, which is essential to prevent galvanic reactions at the specimen and to allow DCPD testing to be performed.

A scaling factor is stress intensity expressed as K, which is used to predict the stress state, stress intensity, near the tip of a crack or notch caused by a load or residual stress. Three types of cracking modes have been identified as Mode I, tensile move where surfaces move directly apart; Mode II, an in-plane shear; and Mode III, which is a tearing non-planar shear.

A crack growth rate can be managed by controlling K and the adverse environment within the autoclave. Such controls and direct measurement of a specimen strain expansion enable plotted graphs of live force, live displacement, force vs. time, force vs. crack length, displacement vs. time, stress vs. strain, stress vs. time, direct current potential drop, dA/dN, (The rate of crack growth, da/dN, where A is the crack length and N is the cycle number, is measured over a range of AK and a plot for constructed frequency and cycles), and temperature vs ti

We claim:

1. A system for a tensile test of a metallic pre-crack specimen in an autoclave comprising a means for application of a load of high temperature, high pressure and an adverse environment and a means for a direct measurement of a metallic pre-crack specimen strain and extension responsive to the load.

2. The system defined in claim 1, further comprising a load frame in fluid communication with an autoclave for production of high temperature, high pressure and hostile environment therein.

3. system defined in claim 2, wherein a specimen is loaded through a pull-rod that penetrates the autoclave wall and moves through a sliding seal.

4. The system defined in claim 3, wherein a pre-crack CT (compact tension) specimen is pinned between two specimen grips mounted on the pull-rod.

5. The system defined in claim 4, further comprising upper and lower LVDT movable brackets contiguous with a specimen, each bracket retaining a vertical slidable rod that penetrates the autoclave wall and moves through a sliding seal, each rod including an LVDT near a distal end of each slidable rod.

6. The system defined in claim 5, wherein each rod serves as a core of a respective LVDT that surrounds each rod.

7. The system defined in claim 6, wherein each LVDT is modified such that the core thereof is within a pressure boundary whereby an internal LVDT is submitted to full system pressure.

8. The system defined in claim 7, a pressure barrier extends well above the autoclave such that a high autoclave temperature does not affect LVDT performance.

9. The system defined in claim 8, wherein the load applied elongates a specimen moves the upper and lower contiguous LVDT moveable brackets and slidable rods retained by each bracket, a difference in measurement between the upper and lower LVDT is an actual extension of the specimen.

10. The system defined in claim 9, wherein direct measurement of a specimen extension enables precision of a plurality of cyclic loading wave forms and accurate calculation of crack growth rates.

11. The system defined in claim 10, wherein the metallic specimen includes a pre-existing crack prior to a tensile test.

12. The system defined in claim 11, wherein a specimen is round, flat, a compact tension, or a single edge notched tension specimen.

13. The system defined in claim 12, wherein an adverse environment within an autoclave is a gas mixture selected from a group comprising nitrogen, hydrogen, carbon, oxygen, steam, H2S, CO2, or CH4 or a combination thereof.

14. The system defined in claim 13, wherein an adverse environment further comprises a condition of combined elevated temperature and elevated pressure, provided in an autoclave, at temperatures up to 600 C and pressures up to 41 MPa (6000 psi)

15. The system defined if claim 14, further comprising an electrical isolation of the specimen, for prevention of galvanic reactions between the specimen and the grips.

16. The system defined in claim 15, further comprising a pair of specimen grips wherein a pre-cracked specimen is pinned between the pair of specimen grips prior to testing.

17. The system defined in claim 16, further comprising means for continuous measures of stress-strain inside an autoclave.

18. The system defined in claim 17, wherein the continuous measures of a stress-strain are output to a direct current drop module and to a computer.

19. The system defined in claim 18, further comprising means for scaling stress intensity expressed as K, which is used to predict a stress state/stress intensity near a tip of a pre-crack specimen caused by a load or a residual stress.

20. The system defined in claim 19, further comprising a means for controlling a crack growth rate by an input of K and the adverse environment within an autoclave.

21. The system defined in claim 20, wherein the control of K and the adverse environment and direct measurement of a specimen strain expansion enable a plurality of real-time plotted graphs of live force, live displacement, force vs. time, force vs. crack length, displacement vs. time, stress vs. strain, stress vs. time, direct current potential drop, dA/dN, (The rate of crack growth, da/dN, where A is the crack length and N is the cycle number, is measured over a range of AK and a plot for constructed frequency and cycles), frequency and cycles, and temperature vs time.

22. The system defined in claim 21, further comprising a means to measure crack growth rate of a pre-cracked specimen in an autoclave.

23. The system defined in claim 22, said means to measure crack growth rate comprising electrical current passed through a specimen exposed to high temperature and pressure and a gaseous adverse environment with consequent crack growth, increase of specimen resistance, wherein a potential drop across a specimen is measured.

24. The method for direct measurement of an extension strain of a metallic specimen as defined in claim 23, further comprising the steps of:
Transmitting a direct specimen expansion measurement to a DCPD module;
Processing an electrical resistance of the specimen for increases simultaneous to a crack propagation and potential drop to determine a crack length.

25. The method for direct measurement of an extension strain of a metallic specimen as defined in claim 24, further comprising the step of:
Applying a scaling factor of a stress intensity, K, specimen;
Managing a crack growth rate by controlling K;
Determining a rate of crack growth, da/dN, where A is the crack length and N is the cycle number measured over a range AK;
Plotting constructed frequency and cycles.
